(19) United States
(12) Patent Application Publication
(10) Pub. No.: US 2006/0099495 A1
(43) Pub. Date: May 11, 2006

(54) Cathode and battery

(76) Inventors: Hiroyuki Suzuki, Fukushima (JP); Takehiko Tanaka, Fukushima (JP); Yosuke Konishi, Fukushima (JP); Guohua Li, Fukushima (JP); Satoshi Mizutani, Fukushima (JP); Yosuke Hosoya, Fukushima (JP)

Correspondence Address: William E. Vaughan;Bell, Boyd & Lloyd LLC, P.O. Box 1135, Chicago, IL, 60690, US

(21) Appl. No.: 11/268,359

(22) Filed: Nov. 7, 2005

(30) Foreign Application Priority Data
Nov. 8, 2004 (JP) P2004-324147

(51) Int. Cl. H01M 4/02; H01M 4/52; H01M 4/58

(52) U.S. Cl. 429/128; 429/221; 429/231.95; 429/223; 429/231.1

(57) ABSTRACT

A cathode capable of improving battery characteristics such as continuous charge characteristics and high temperature storage characteristics and a battery using it are provided. An active material layer has a multilayer structure, in which a first layer containing a first active material and a second layer containing a second active material are layered. As the first active material, LiNiO₂ or the like is preferable, and as a second active material, LiFePO₄ or the like having heat stability higher than of the first active material is preferable. Thereby, heat stability can be improved without lowered capacity, and lowered capacity due to oxidation of a separator or the like can be inhibited.

### CROSS REFERENCES TO RELATED APPLICATIONS

The present invention claims priority to Japanese Patent Application JP 2004-324147 filed in the Japanese Patent Office on Nov. 8, 2004, the entire contents of which being incorporated herein by reference.

### BACKGROUND

The present invention relates to a cathode in which a current collector is provided with an active material layer and a battery using it.

In recent years, as portable equipment has been multi-functionalized and highly technically advanced, power consumption of the equipment has become large, and higher capacity of the battery, the power source thereof has been demanded. As a battery meeting such a demand, for example, a lithium ion secondary battery is known. In the lithium ion secondary battery, as a cathode active material, a complex oxide containing lithium (Li) and a transition metal is used in order to increase the battery voltage and the capacity.

However, in traditional lithium ion secondary batteries, when continuously charged for a long time or when stored for a long time at high temperatures, there have been disadvantages that the separator is oxidized by the cathode, or resistance of the cathode is increased due to deterioration of the current collector, leading to lowered capacity. As a method to resolve such disadvantages, a separator with high oxidation resistance may be used, or resistance increase in the cathode may be inhibited by increasing the amount of the electrical conductor to be added to the active material layer, or an additive for preventing deterioration may be used.

However, since the separator with high oxidation resistance has different shutdown characteristics, lowered safety of the battery is concerned. Further, in the method of increasing the electrical conductor, the amount of the active material capable of being filled in the battery is decreased, and therefore the battery capacity is decreased, which is not preferable. Further, when the deterioration inhibitor is used, the manufacturing cost is increased.

Further, as a known technique, it is suggested that in order to obtain superior characteristics in a wide temperature range, the active material layer is formed in a multilayer structure with different specific surface areas of the active material (for example, refer to Japanese Unexamined Patent Application Publication No. 2003-77482). However, under severe conditions such as continuous charge for a long time or long time storage at high temperatures, it has been difficult to obtain sufficient characteristics.

### SUMMARY

In view of the foregoing, in the present invention, it is desirable to provide a cathode capable of improving battery characteristics such as continuous charge characteristics and high temperature storage characteristics and a battery using it.

According to an embodiment of the present invention, there is provided a cathode, in which a current collector is provided with an active material layer, and the active material layer has a multilayer structure containing different active materials.

According to an embodiment of the present invention, there is provided a battery including a cathode, an anode, and an electrolyte, in which the cathode has a current collector and an active material layer provided on the current collector, and the active material layer has a multilayer structure containing different active materials.

According to the embodiment of the present invention, cathode has the multilayer structure containing different active materials. Therefore, for example, by using active materials with different heat stability, heat stability can be improved without lowering characteristics such as a capacity. Therefore, according to the battery of the embodiment of the present invention, deterioration of characteristics can be inhibited even if charged continuously for a long time or stored at high temperatures.

Additional features and advantages are described herein, and will be apparent from, the following Detailed Description and the figures.

### BRIEF DESCRIPTION OF THE FIGURES

FIG. 1 is a cross section showing a structure of a cathode according to an embodiment of the present invention.

FIG. 2 is a cross section showing a structure of another cathode of the present invention.

FIG. 3 is a cross section showing a structure of still another cathode of the present invention.

FIG. 4 is a cross section showing a structure of a first secondary battery using the cathode according to the embodiment of the present invention.

FIG. 5 is a cross section showing an enlarged part of a spirally wound electrode body in the secondary battery shown in FIG. 4.

FIG. 6 is an exploded perspective view showing a structure of a second secondary battery using the cathode according to the embodiment of the present invention.

FIG. 7 is a cross section showing a structure taken along line I-I of a spirally wound electrode body shown in FIG. 6.

### DETAILED DESCRIPTION

An embodiment of the present invention will be hereinafter described in detail with reference to the drawings.

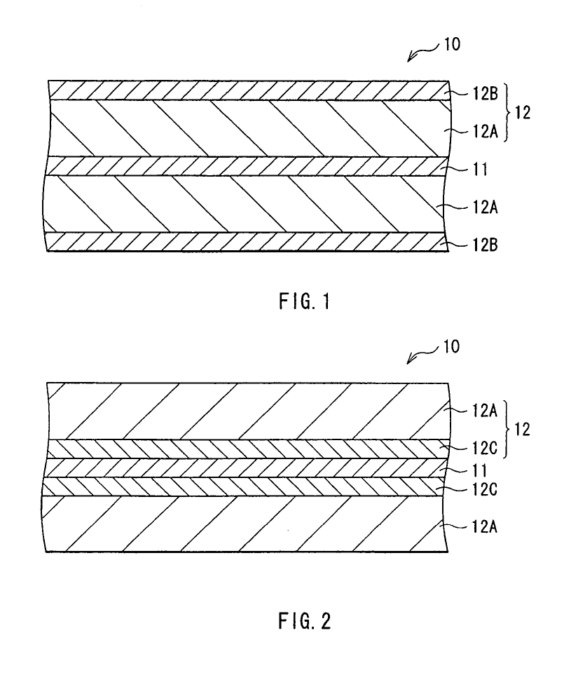

FIG. 1 shows a structure of a cathode 10 according to an embodiment of the present invention. The cathode 10 has a structure in which, for example, an active material layer 12 is provided on a current collector 11 having a pair of opposed faces. In FIG. 1, the case, in which the active material layer 12 is provided on both faces of the current collector 11. However, the active material layer 12 may be provided only on a single face. The current collector 11 is made of, for example, a metal foil such as an aluminum (Al) foil, a nickel (Ni) foil, and a stainless foil.

The active material layer 12 contains, for example, a cathode material capable of inserting and extracting lithium as an active material. If necessary, the active material layer 12 may contain a conductive material such as a carbon material and a binder such as polyvinylidene fluoride. As a cathode material capable of inserting and extracting lithium, for example, a chalcogen compound containing no lithium such as titanium sulfide (TiS₂), molybdenum sulfide (MoS₂), niobium selenide (NbSe₂), and vanadium oxide (V₂O₅), or a lithium-containing compound can be cited.

The lithium-containing compound is preferable since some lithium-containing compounds can provide a high voltage and a high energy density. As such a lithium-containing compound, for example, a complex oxide containing lithium and transition metal elements, or a phosphate compound containing lithium and transition metal elements can be cited. Examples of the chemical formula thereof include LiₓMIO₂ and Li_{y}MIIPO₄. In the formula, MI and MII represent one or more transition metal elements. Values of x and y vary according to charge and discharge states of the battery, and the values of x and y are generally in the range of 0.05≦x≦1.10 and 0.05≦y≦1.10.

In particular, as a complex oxide containing lithium and transition metal elements, a compound containing at least one of nickel, cobalt (Co), and manganese (Mn) is preferable, since such a compound can provide a higher voltage. As a specific example, a lithium nickel complex oxide (LiₓNiO₂), a lithium cobalt complex oxide (LiₓCoO₂), a lithium nickel cobalt complex oxide (LiₓNi_{1-z}Co_{z}O₂ (0<z<1)), a lithium nickel manganese cobalt complex oxide (LiₓNi_{1-v-w}MnᵥCO_{w}O₂ (0<v, 0<w, v+w<1)), or lithium manganese complex oxide having a spinel type structure (LiMn₂O₄) or the like can be cited. The complex oxide containing nickel is preferable, since such a complex oxide can provide a high capacity and superior cycle characteristics. The complex oxide may contain other elements in addition to lithium and at least one of nickel, cobalt, and manganese.

Further, as a specific example of the phosphate compound containing lithium and transition metal elements, for example, a lithium iron phosphate compound (Li_{y}FePO₄) or a phosphate compound containing lithium, iron, (Fe), and other elements (Li_{y}Fe₁₋ᵤMIIIᵤPO₄) can be cited. In the formula, MIII is at least one from the group consisting of nickel, cobalt, manganese, copper (Cu), zinc (Zn), magnesium (Mg), chromium (Cr), vanadium (V), molybdenum (Mo), titanium (Ti), aluminum, niobium (Nb), boron (B), and gallium (Ga), and u is in the range of 0<u<1.

The active material layer 12 has a first layer 12A containing a first active material provided on the current collector 11 side, and a second layer 12B containing a second active material provided on the surface side opposite thereof. The first active material and the second active material have different compositions from each other, and thereby the active material layer 12 has a multilayer structure. For example, as a second active material, a material with heat stability higher than of the first active material is preferable for inhibiting lowered capacity while improving heat stability on the surface side. Heat stability of the active material is preferably determined by, for example, weight loss at 400 deg C. by thermogravimetry. It can be determined that the smaller the decrease ratio is, the more stable it is.

As the first active material, a complex oxide containing lithium and transition metal elements is preferable. As the second active material, a phosphorus compound containing lithium and transition metal elements is preferable. In particular, as the first active material, a complex oxide containing lithium and nickel is preferable, and as the second active material, a phosphorus compound containing lithium and iron is preferable. It is because a high capacity can be obtained, and heat stability can be improved.

The first layer 12A may contain other active material in addition to the first active material, or may contain a plurality of the first active materials. Similarly, the second layer 12B may contain other active material in addition to the second active material, or may contain a plurality of the second active materials. In this case, the first layer 12A and the second layer 12B may contain the same active material.

Further, as shown in FIG. 2, the cathode 10 may have a second layer 12C containing the foregoing second active material between the current collector 11 and the first layer 12A. For example, when the second active material with heat stability higher than of the first active material is used, heat stability on the current collector 11 side can be improved, and deterioration of the current collector 11 can be inhibited.

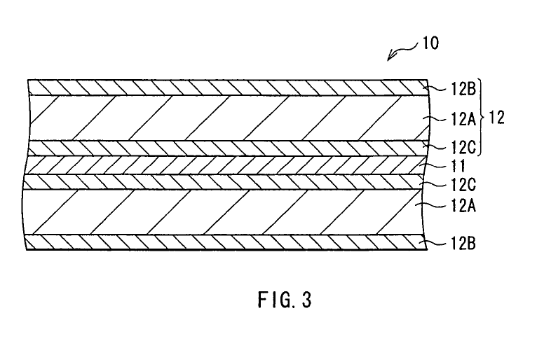

Further, as shown in FIG. 3, it is possible that both the second layer 12B and the second layer 12C may be provided. In this case, the compositions of the second active materials used for the second layer 12B and the second layer 12C may be identical or different.

The cathode 10 can be manufactured by, for example, mixing an active material, and if necessary a electrical conductor and a binder, dispersing the mixture in a solvent such as N-methyl-2-pyrrolidone, coating the current collector 11 with the resultant, drying the solvent, compression-molding the resultant by a rolling press machine or the like to form the first layer 12A, and the second layers 12B and 12C.

The cathode 10 is used for a secondary battery as follows, for example.

(First Secondary Battery)

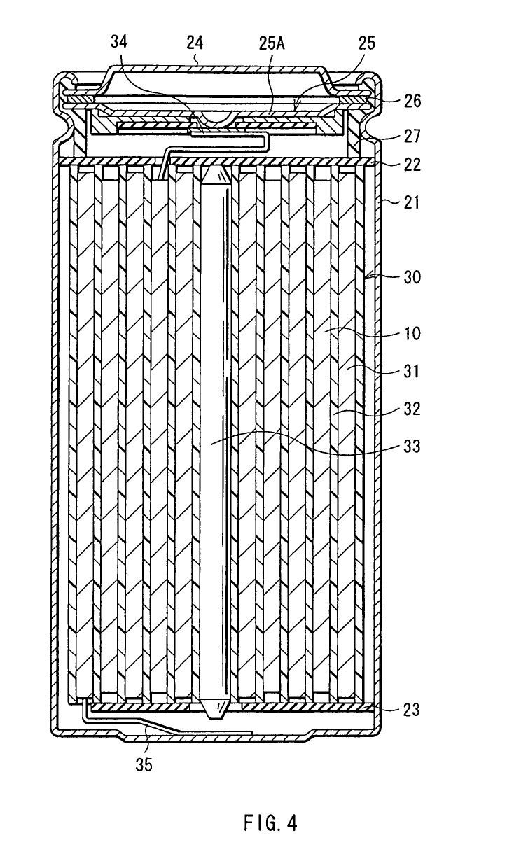

FIG. 4 shows a cross sectional structure of a first secondary battery using the cathode 10 according to this embodiment. The secondary battery is a so-called cylinder-type battery, and has a spirally wound electrode body 30 in which a strip-shaped anode 31 and the strip-shaped cathode 10 are wound with a separator 32 inbetween inside a battery can 21 in the shape of approximately hollow cylinder. The battery can 21 is made of, for example, iron plated by nickel. One end of the battery can 21 is closed, and the other end thereof is opened. Inside the battery can 21, a pair of insulating plates 22 and 23 is respectively arranged perpendicular to the winding periphery face, so that the spirally wound electrode body 30 is sandwiched between the insulating plates 22 and 23.

At the open end of the battery can 21, a battery cover 24, and a safety valve mechanism 25 and a PTC (Positive Temperature Coefficient) device 26 provided inside the battery cover 24 are attached by being caulked through a gasket 27. Inside of the battery can 21 is thereby closed. The battery cover 24 is, for example, made of a material similar to that of the battery can 21. The safety valve mechanism 25 is electrically connected to the battery cover 24 through the PTC device 26. When the internal pressure of the battery becomes a certain level or more by internal short circuit, external heating or the like, a disk plate 25A flips to cut the electrical connection between the battery cover 24 and the spirally wound electrode body 30. When temperatures rise, the PTC device 26 limits a current by increasing the resistance value to prevent abnormal heat generation by a large current. The gasket 27 is made of, for example, an insulating material. The surface of the gasket 27 is coated with asphalt.

For example, a center pin 33 is inserted in the center of the spirally wound electrode body 30. A lead 34 made of aluminum or the like is connected to the cathode 10 of the spirally wound electrode body 30. A lead 35 made of nickel or the like is connected to the anode 31. The lead 34 is electrically connected to the battery cover 24 by being welded to the safety valve mechanism 25. The lead 35 is welded and electrically connected to the battery can 21.

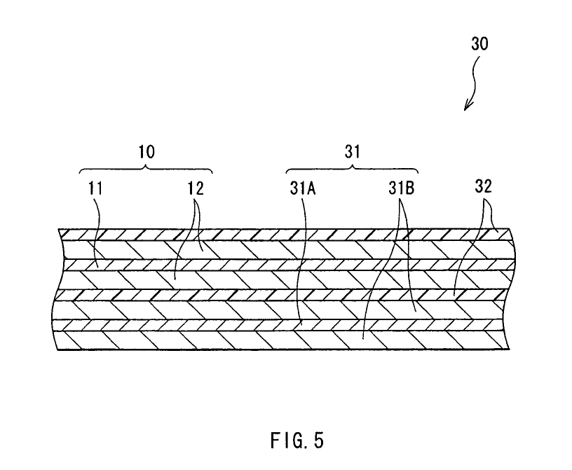

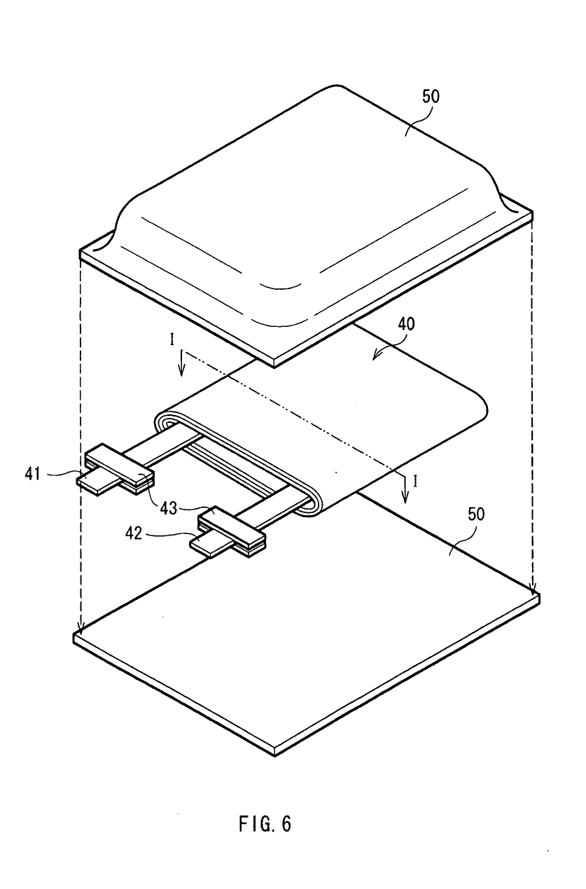

FIG. 5 shows an enlarged part of the spirally wound electrode body 30 shown in FIG. 4. The anode 31 has a structure in which, for example, an active material layer 31B is provided on a current collector 31A having a pair of opposed faces. The current collector 31A is made of, for example, a metal foil such as a copper foil, a nickel foil, and a stainless foil.

The active material layer 31B contains, for example, one or more anode materials capable of inserting and extracting lithium as an active material. As such an anode material, for example, a material capable of inserting and extracting lithium, containing at least one of metal elements and metalloid elements as an element can be cited. Such an anode material is preferably used, since a high energy density can be thereby obtained. The anode material may be a simple substance, an alloy, or a compound of a metal element or a metalloid element, or may have one or more phases thereof at least in part. In the present invention, alloys include an alloy containing one or more metal elements and one or more metalloid elements in addition to an alloy composed of two or more metal elements. Further, an alloy may contain nonmetallic elements. The texture thereof includes a solid solution, a eutectic crystal (eutectic mixture), an intermetallic compound, and a structure, in which two or more thereof coexist.

As a metal element or a metalloid element composing the anode material, for example, a metal element or a metalloid element capable of forming an alloy with lithium can be cited. Specifically, magnesium, boron, aluminum, gallium, indium (In), silicon (Si), germanium (Ge), tin (Sn), lead (Pb), bismuth (Bi), cadmium (Cd), silver (Ag), zinc, hafnium (Hf), zirconium (Zr), yttrium (Y), palladium (Pd), platinum (Pt) or the like can be cited.

Specially, as such an anode material, a material containing a metal element or a metalloid element of Group 14 in the long period periodic table as an element is preferable. A material containing at least one of silicon and tin as an element is particularly preferable. Silicon and tin have a high ability to insert and extract lithium, and provide a high energy density. Specifically, for example, a simple substance, an alloy, or a compound of silicon; a simple substance, an alloy, or a compound of tin; or a material having one or more phases thereof at least in part can be cited.

As an alloy of tin, for example, an alloy containing at least one from the group consisting of silicon, nickel, copper, iron, cobalt, manganese, zinc, indium, silver, titanium, germanium, bismuth, antimony (Sb), and chromium as a second element other than tin can be cited. As an alloy of silicon, for example, an alloy containing at least one from the group consisting of tin, nickel, copper, iron, cobalt, manganese, zinc, indium, silver, titanium, germanium, bismuth, antimony, and chromium as a second element other than silicon can be cited.

As a compound of tin or a compound of silicon, for example, a compound containing oxygen (O) or carbon (C) can be cited. In addition to tin or silicon, the compound may contain the foregoing second element.

As such an anode material, a CoSnC-containing material containing tin, cobalt, and carbon as an element, in which the carbon content is from 9.9 wt % to 29.7 wt %, and the ratio of cobalt to the total of tin and cobalt is from 30 wt % to 70 wt % is preferable. In such a composition range, a high energy density can be obtained, and superior cycle characteristics can be obtained.

The CoSnC-containing material may further contain other elements if necessary. As other element, for example, silicon, iron, nickel, chromium, indium, niobium, germanium, titanium, molybdenum, aluminum, phosphorus (P), gallium, or bismuth is preferable. Two or more thereof may be contained, since a capacity or cycle characteristics can be thereby further improved.

The CoSnC-containing material has a phase containing tin, cobalt, and carbon. The phase preferably has a structure with low crystallinity or an amorphous structure. Further, it is preferable that in the CoSnC-containing material, at least part of carbon as the element is bonded to a metal element or a metalloid element, which is other element. It is thinkable that lowered cycle characteristics are caused by cohesion or crystallization of tin or the like; however, such cohesion or crystallization can be inhibited by bonding carbon to other element.

As a measuring method for examining bonding state of elements, for example, X-ray Photoelectron Spectroscopy (XPS) can be cited. In XPS, in the case of graphite, the peak of 1s orbital of carbon (C1s) is observed at 284.5 eV in the apparatus, in which energy calibration is made so that the peak of 4f orbital of gold atom (Au4f) is observed at 84.0 eV. In the case of surface contamination carbon, the peak is observed at 284.8 eV. Meanwhile, in the case of higher electric charge density of carbon element, for example, when carbon is bonded to a metal element or a metalloid element, the peak of C1s is observed in the region lower than 284.5 eV. That is, when the peak of the composite wave of C1s obtained in the CoSnC-containing material is observed in the region lower than 284.5 eV, at least part of carbon contained in the CoSnC-containing material is bonded to the metal element or the metalloid element, which is other element.

In XPS measurement, for example, the peak of C1s is used for correcting the energy axis of spectrums. Since surface contamination carbon generally exists on the surface, the peak of C1s of the surface contamination carbon is set to 284.8 eV, and the peak is used as an energy reference. In XPS measurement, the waveform of the peak of C1s is obtained as a form including the peak of the surface contamination carbon and the peak of carbon in the CoSnC-containing material. Therefore, by performing analysis by using a commercially available software or the like, the peak of the surface contamination carbon and the peak of carbon in the CoSnC-containing material are separated. In the analysis of the waveform, the position of the main peak existing on the lowest bound energy side is set to the energy reference (284.8 eV).

As an anode material capable of inserting and extracting lithium, for example, a carbon material such as pyrolytic carbons, cokes, graphites, glassy carbons, organic high molecular weight compound fired body, carbon fiber, and activated carbon, or a high molecular weight compound such as polyacetylene may be used. Specially, the carbon material is preferably used, since change of crystal structure associated with insertion and extraction of lithium is very little, and superior cycle characteristics can be obtained. For example, the carbon material may be used with the foregoing anode material containing a metal element or a metalloid element as an element.

The separator 32 separates the cathode 10 from the anode 31, prevents current short circuit due to contact of both electrodes, and lets through lithium ions. The separator 32 is made of, for example, a synthetic resin porous film composed of polytetrafluoroethylene, polypropylene, polyethylene or the like, or a ceramics porous film. The separator 32 can have a structure in which two or more of the foregoing porous films are layered.

An electrolytic solution as the liquid electrolyte is impregnated in the separator 32. The electrolytic solution contains, for example, a solvent, and an electrolyte salt dissolved in the solvent, and may contain various additives if necessary.

As a solvent, for example, a nonaqueous solvent such as propylene carbonate, ethylene carbonate, diethyl carbonate, dimethyl carbonate, 4-fluoro-1,3-dioxolane-2-one, 4,5-difluoro-1,3-dioxolane-2-one, 1,2-dimethoxyethane, 1,2-diethoxyethane, γ-butyrolactone, tetrahydrofuran, 2-methyltetrahydrofuran, 1,3-dioxolane, 4-methy-1,3-dioxolane, diethyl ether, sulfolane, methyl sulfolane, acetonitrile, propionitrile, anisole, ester acetate, ester butyrate, ester propionate, and vinylene carbonate can be cited. One solvent may be used singly, or two or more thereof may be used by mixing.

As an electrolyte salt, for example, a lithium salt such as LiPF₆, LiBF₄, LiClO₄, LiAsF₆, LiB(C₆H₅)₄, LiCl, LiBr, LiCH₃SO₃, and LiCF₃SO₃ can be cited. One electrolyte salt may be used, or two or more thereof may be used by mixing.

The secondary battery can be manufactured, for example, as follows.

First, as described above, the cathode 10 is formed, and for example, the anode 31 is similarly formed. Then, the leads 34 and 35 are attached to the current collectors 11 and 31A. After that, the cathode 10 and the anode 31 are wound with the separator 32 inbetween. An end of the lead 35 is welded to the battery can 21, and an end of the lead 34 is welded to the safety valve mechanism 25. The wound cathode 10 and the wound anode 31 are sandwiched between the pair of insulating plates 22 and 23, and contained inside the battery can 21. Subsequently, the electrolytic solution is injected into the battery can 21, and impregnated in the separator 32. After that, at the open end of the battery can 21, the battery cover 24, the safety valve mechanism 25, and the PTC device 26 are fixed by being caulked through the gasket 27. The secondary battery shown in FIG. 4 is thereby completed.

In the secondary battery, when charged, for example, lithium ions are extracted from the cathode 10, and are inserted in the anode 31 through the electrolytic solution. When discharged, for example, lithium ions are extracted from the anode 31, and are inserted in the cathode 10 through the electrolytic solution. Then, since for example, the cathode 10 is provided with the first layer 12A, and the second layers 12B and 12C having heat stability higher than of the first layer 12A, oxidation of the separator 32 is inhibited, and increase in resistance due to deterioration of the current collector 11 is inhibited even when continuously charged or stored at high temperatures.

(Second Secondary Battery)

FIG. 6 shows a structure of a second secondary battery. The secondary battery is a so-called laminated film-type secondary battery. In the secondary battery, a spirally wound electrode body 40 on which leads 41 and 42 are attached is contained inside a film package member 50.

The leads 41 and 42 are respectively made of, for example, a metal material such as aluminum, copper, nickel, and stainless, and are directed from inside to outside of the package member 50 in the same direction, for example.

The package member 50 is made of a rectangular aluminum laminated film in which, for example, a nylon film, an aluminum foil, and a polyethylene film are bonded together in this order. The package member 50 is, for example, arranged so that the polyethylene film side and the spirally wound electrode body 40 are opposed, and the respective outer edges are contacted to each other by fusion bonding or an adhesive. Adhesive films 43 to protect from outside air intrusion are inserted between the package member 50 and the leads 41 and 42. The adhesive film 43 is made of a material having contact characteristics to the leads 41 and 42, for example, a polyolefin resin of polyethylene, polypropylene, modified polyethylene, and modified polypropylene.

The package member 50 may be made of a laminated film having a different structure, a high molecular weight film such as polypropylene, or a metal film, instead of the foregoing aluminum laminated film.

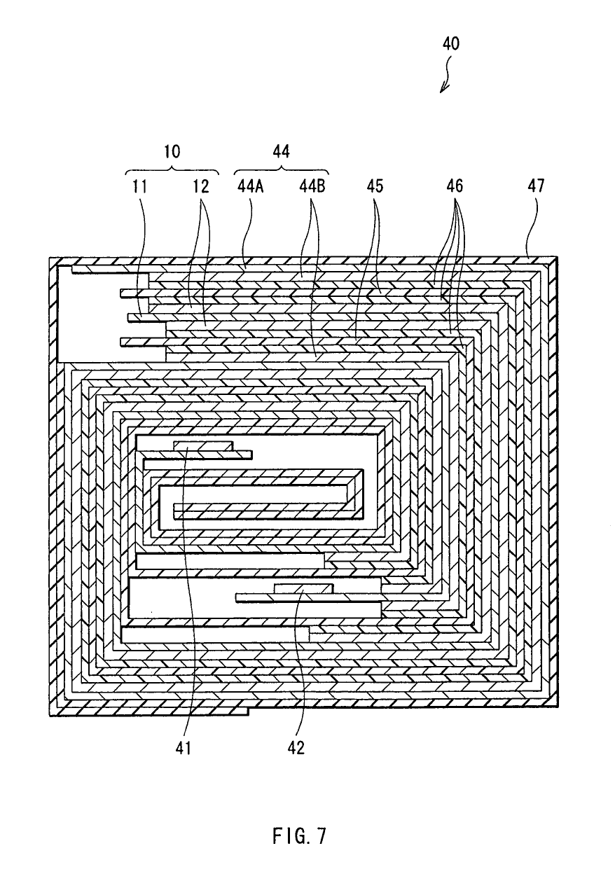

FIG. 7 shows a cross sectional structure taken along line I-I of the spirally wound electrode body 40 shown in FIG. 6. In the spirally wound electrode body 40, the cathode 10 and an anode 44 are layered with a separator 45 and an electrolyte layer 46 inbetween and wound. The outermost periphery thereof is protected by a protective tape 47.

The anode 44 has a structure in which an active material layer 44B is provided on the both faces of the current collector 44A. Structures of the current collector 44A, the active material layer 44B, and the separator 45 are similar to of the current collector 31A, the active material layer 31B, and the separator 32 in the first secondary battery described above.

The electrolyte layer 46 is in a so-called gelatinous state, containing the electrolytic solution and a high molecular weight compound to become a holding body, which holds the electrolytic solution. The gelatinous electrolyte is preferable, since a high ion conductivity can be thereby obtained, and leak of the battery can be thereby prevented. The structure of the electrolytic solution (that is, a solvent, an electrolyte salt and the like) is similar to of the first secondary battery described above. As a high molecular weight material, for example, an ether high molecular weight compound such as polyethylene oxide and a cross-linked body containing polyethylene oxide, an ester high molecular weight compound such as poly methacrylate or an acrylate high molecular weight compound, or a polymer of vinylidene fluoride such as polyvinylidene fluoride and a copolymer of vinylidene fluoride and hexafluoro propylene can be cited. One or more thereof are used by mixing. In particular, in view of redox stability, a fluorinated high molecular weight compound such as the polymer of vinylidene fluoride is desirable.

The secondary battery can be manufactured, for example, as follows.

First, as described above, the cathode 10 and the anode 44 are formed. Then, the cathode 10 and the anode 44 are respectively coated with a precursor solution containing an electrolytic solution, a high molecular weight compound, and a mixed solvent. The mixed solvent is volatilized to form the electrolyte layer 46. Then, the leads 41 and 42 are attached to the current collectors 11 and 44A. Subsequently, the cathode 10 and the anode 44 formed with the electrolyte layer 46 are layered with the separator 45 inbetween to obtain a lamination. After that, the lamination is wound in the longitudinal direction, the protective tape 47 is adhered to the outermost periphery thereof to form the spirally wound electrode body 40. Lastly, for example, the spirally wound electrode body 40 is sandwiched between the package members 50, and outer edges of the package members 50 are contacted by thermal fusion-bonding or the like to enclose the spirally wound electrode body 40. Then, the adhesive films 43 are inserted between the lead 41, 42 and the package member 50. Thereby, the secondary battery shown in FIG. 6 and FIG. 7 is completed.

Further, the secondary battery may be fabricated as follows. First, the cathode 10 and the anode 44 are formed, and the leads 41 and 42 are attached on the cathode 10 and the anode 44. After that, the cathode 10 and the anode 44 are layered with the separator 45 inbetween and wound. The protective tape 47 is adhered to the outermost periphery thereof, and a winding body as the precursor of the spirally wound electrode body 40 is formed. Next, the winding body is sandwiched between the package members 50, the outermost peripheries except for one side are thermal fusion-bonded to obtain a pouched state, and the spirally wound electrode body is contained inside the package member 50. Subsequently, a composition of matter for electrolyte containing an electrolytic solution, a monomer as the raw material for the high molecular weight compound, a polymerization initiator, and if necessary other material such as a polymerization inhibitor is prepared, which is injected into the package member 50.

After the composition of matter for electrolyte is injected, the opening of the package member 50 is thermal fusion-bonded and hermetically sealed in the vacuum atmosphere. Next, the resultant is heated to polymerize the monomer to obtain a high molecular weight compound. Thereby, the gelatinous electrolyte layer 46 is formed, and the secondary battery shown in FIG. 6 and FIG. 7 is assembled.

The secondary battery works similarly to the first secondary battery described above.

As above, according to this embodiment, the cathode 10 has a multilayer structure containing different active materials. Therefore, by using the first active material and the second active material with different heat stability, heat stability can be improved without lowering characteristics such as a capacity. Consequently, for example, even when the battery is continuously charged for a long time or stored at high temperatures, increase in resistance due to deterioration of oxidation of the separators 32 and 45 or deterioration of the current collector 11 can be inhibited, and capacity deterioration can be inhibited.

In particular, when the complex oxide containing lithium and transitional metal elements, specially the complex oxide containing lithium and nickel is used as the first active material, and the phosphorus compound containing lithium and transition metal elements, specially the phosphorus compound containing lithium and iron is used as the second active material, higher effects can be obtained.

### EXAMPLES

Further, specific examples of the present invention will be described in detail.

### Examples 1 to 3

The cathode 10 was formed as follows. First, as the first active material, lithium nickel complex oxide (LiNiO₂) powder was prepared. 96 wt % of the lithium nickel complex oxide; 1 wt % of carbon black as the electrical conductor; and 3 wt % of polyvinylidene fluoride as the binder were mixed. The mixture was dispersed in N-methyl-2-pyrrolidone as the solvent. Both faces of the current collector 11 made of an aluminum foil were coated with the foregoing mixture, which was then dried. Thereby the first layer 12A was formed.

Next, as the second active material, lithium iron phosphorus compound (LiFePO₄) powder with heat stability higher than of the lithium nickel complex oxide was prepared. 92 wt % of the lithium iron phosphorus compound; 6 wt % of graphite as the electrical conductor; and 2 wt % of polyvinylidene fluoride as the binder were mixed. The mixture was dispersed in N-methyl-2-pyrrolidone as the solvent. The first layer 12A was coated with the foregoing mixture, which was then dried. Thereby the second layer 12B was formed, which was subsequently compression-molded by a rolling press machine to obtain the cathode 10.

By using the fabricated cathode 10, the cylindrical-type secondary battery shown in FIG. 4 was fabricated. Then, the structure of the anode 31 was changed in Examples 1 to 3. In Example 1, artificial graphite powder was used as an active material. 90 wt % of the artificial graphite and 10 wt % of polyvinylidene fluoride as the binder were mixed. The mixture was dispersed in N-methyl-2-pyrrolidone as the solvent. Both faces of the current collector 31A made of a copper foil were coated with the foregoing mixture, which was then dried and compression-molded by a rolling press machine to form the anode 31. In Example 2, the anode 31 was formed as in Example 1, except that cobalt-tin alloy powder was used as an active material, and the mixture of 76 wt % of the cobalt-tin alloy; 20 wt % of the graphite as the electrical conductor and the active material; and 4 wt % of polyvinylidene fluoride as the binder was used. In Example 3, the anode 31 was formed as in Example 1, except that CoSnC-containing material powder was used as an active material, and the mixture of 76 wt % of the CoSnC-containing material; 20 wt % of the graphite as the electrical conductor and the active material; and 4 wt % of polyvinylidene fluoride as the binder was used.

The CoSnC-containing material was synthesized as follows. That is, carbon powder was added to the cobalt-tin alloy powder, which was dry-mixed. Then the mixture was synthesized by utilizing mechanochemical reaction by using a planetary ball mill. Regarding the formed CoSnC-containing material, the composition was analyzed. In the result, the cobalt content was 29.3 wt %, the tin content was 49.9 wt %, and the carbon content was 19.8 wt %. The carbon content was measured by a carbon sulfur analyzer. The contents of cobalt and tin were measured by ICP (Inductively Coupled Plasma) optical emission spectroscopy. Further, regarding the obtained CoSnC-containing material, X-ray diffraction was performed. In the result, the diffraction peak having a wide half value width with the diffraction angle 2θ of 1.0 degree or more was observed in the range of diffraction angle 2θ=20 to 50 degrees. Further, when XPS was performed on the CoSnC-containing material, the peak of C1s in the CoSnC-containing material was obtained in the region lower than 284.5 eV. That is, it was confirmed that carbon in the CoSnC-containing material was bonded to other element.

Further, for the electrolytic solution, the electrolytic solution in which LiPF₆ was dissolved at a concentration of 1 mol/l in a solvent including 50 volume % of ethylene carbonate and 50 volume % of diethyl carbonate were mixed was used.

As Comparative examples 1 and 2 relative to Examples 1 to 3, cathodes were formed as in Examples 1 to 3, except that only the first layer was formed on the current collector and the second layer was not formed. The surface density of the active material layer 12 was identical to of Examples 1 to 3. Regarding the cathodes of Comparative examples 1 and 2, secondary batteries were fabricated as in Examples 1 to 3. Then, an anode similar to of Example 1 was used for Comparative example 1, and an anode similar to of Comparative example 2 was used for Comparative example 2.

Regarding the fabricated secondary batteries of Examples 1 to 3 and Comparative examples 1 and 2, continuous charge characteristics and high temperature storage characteristics were evaluated as follows. The results are shown in Table 1.

(Continuous Charge Characteristics)

First, after constant current and constant voltage charge at a current value of 0.5 A and at the upper limit voltage of 4.2 V was performed at 23 deg C., constant current discharge was performed at a constant current of 2 A (high load) or 0.2 A (low load) to the final voltage of 2.5 V. Then, the discharge capacity before continuous charge was measured. Next, constant current and constant voltage charge at a current value of 0.5 A and at the upper limit voltage of 4.2 V was performed at 23 deg C. for 60 days continuously. After that, constant current discharge was performed at a constant current of 2 A or 0.2 A to the final voltage of 2.5 V. Then, the discharge capacity after continuous charge was measured. From the obtained results, regarding high load discharge and low load discharge, the retention ratio of the discharge capacity after continuous charge relative to the discharge capacity before continuous charge was respectively obtained.

(High Temperature Storage Characteristics)

First, after constant current and constant voltage charge at a current value of 0.5 A and at the upper limit voltage of 4.2 V was performed at 23 deg C., constant current discharge was performed at a constant current of 2 A or 0.2 A to the final voltage of 2.5 V. Then, the discharge capacity before storage was measured. Next, after constant current and constant voltage charge at a current value of 0.5 A and at the upper limit voltage of 4.2 V was performed at 23 deg C., the batteries were stored for 60 days at 60 deg C. After that, constant current discharge was performed at a constant current of 2 A or 0.2 A to the final voltage of 2.5 V. Then, the discharge capacity after storage was measured. From the obtained results, regarding high load discharge and low load discharge, the retention ratio of the discharge capacity after storage relative to the discharge capacity before storage was respectively obtained.

TABLE 1

| | | | | | | High temperature | |
|---|---|---|---|---|---|---|---|
| | | | | Continuous charge | | storage | |
| | Cathode | | | characteristics (%) | | characteristics (%) | |
| | | Second layer | | High load | Low load | High load | Low load |
| | First layer | on surface side | Anode | 2 A | 0.2 A | 2 A | 0.2 A |
| Example 1 | LiNiO₂ | LiFePO₄ | Artificial | 87 | 93 | 82 | 90 |
| | | | graphite | | | | |
| Example 2 | LiNiO₂ | LiFePO₄ | CoSn alloy | 84 | 90 | 79 | 88 |
| Example 3 | LiNiO₂ | LiFePO₄ | CoSnC- | 88 | 92 | 81 | 88 |
| | | | containing | | | | |
| | | | material | | | | |

| | | | | | | |
|---|---|---|---|---|---|---|
| Comparative | LiNiO₂ | Artificial | 68 | 79 | 69 | 82 |
| example 1 | | graphite | | | | |
| Comparative | LiNiO₂ | CoSn alloy | 65 | 77 | 63 | 78 |
| example 2 | | | | | | |

As shown in Table 1, according to Examples 1 to 3, in which the second layer 12B was provided on the surface of the cathode 10, both continuous charge characteristics and high temperature characteristics could be improved compared to Comparative examples 1 and 2, in which the second layer 12B was not provided on the surface of the cathode 10. That is, it was found that when the second layer 12B using the second active material with high heat stability was provided on the surface side, capacity deterioration due to continuous charge and high temperature storage could be inhibited.

### Examples 4 to 6

As Example 4, the cathode 10 was formed as in Example 1, except that instead of the second layer 12B, the second layer 12C was formed between the current collector 11 and the first layer 12A. The second layer 12C was formed as the second layer 12B of Example 1 by using a lithium iron phosphorus compound as the second active material.

As Example 5, the cathode 10 was formed as in Example 1, except that in addition to the second layer 12B, the second layer 12C was formed between the current collector 11 and the first layer 12A. The second layer 12C was formed as the second layer 12B of Example 1 by using a lithium iron phosphorus compound as the second active material.

As Example 6, the cathode 10 was formed as in Example 1, except that in addition to the second layer 12B, the second layer 12C was formed between the current collector 11 and the first layer 12A, and lithium nickel manganese cobalt complex oxide (LiNi_{0.45}Mn_{0.3}Co_{0.25}O₂) was used as the first active material. The second layer 12C was formed as the second layer 12B of Example 1 by using a lithium iron phosphorus compound as the second active material.

For the cathode 10 of Examples 4 to 6, secondary batteries were also fabricated by using artificial graphite as the anode active material as in Example 1, and continuous charge characteristics and high temperature storage characteristics were evaluated. The results are shown in Table 2 together with the result of Comparative example 1.

TABLE 2

| | Cathode | | | | | | |
|---|---|---|---|---|---|---|---|
| | Second | | | | | High temperature | |
| | layer on | | | Continuous charge | | storage | |
| | current | | Second | characteristics (%) | | characteristics (%) | |
| | collector | | layer on | High load | Low load | High load | Low load |
| | side | First layer | surface side | 2 A | 0.2 A | 2 A | 0.2 A |
| Example 4 | LiFePO₄ | LiNiO₂ | — | 79 | 80 | 80 | 81 |
| Example 5 | LiFePO₄ | LiNiO₂ | LiFePO₄ | 93 | 94 | 95 | 96 |
| Example 6 | LiFePO₄ | LiNi_{0.45}Mn_{0.3}Co_{0.25}O₂ | LiFePO₄ | 94 | 95 | 96 | 97 |

| | | | | | |
|---|---|---|---|---|---|
| Comparative | LiNiO₂ | 68 | 79 | 69 | 82 |
| example 1 | | | | | |

As shown in Table 2, according to Example 4, in which the second layer 12C was provided between the current collector 11 and the first layer 12A, continuous charge characteristics and high temperature characteristics in high load discharge could be improved to the degree of low load discharge compared to Comparative example 1. Further, according to Examples 5 and 6, in which both the second layer 12B on the surface side and the second layer 12C on the current collector side were provided, both continuous charge characteristics and high temperature storage characteristics could be improved, and in particular, characteristics of high load discharge could be improved to the degree of low load discharge.

That is, it was found that when the second layer 12C using the second active material with high heat stability was provided on the current collector side, capacity deterioration due to continuous charge and high temperature storage could be inhibited. It was also found that when the second layers were provided both on the surface side and the current collector side, higher effects could be obtained.

The present invention has been described with reference to the embodiment and the examples. However, the present invention is not limited to the embodiment and the examples, and various modifications may be made. For example, in the foregoing embodiment and examples, descriptions have been given of the case using the electrolytic solution as the liquid electrolyte or the case using the gelatinous electrolyte in which the electrolytic solution is held in the high molecular weight compound. However, other electrolyte may be used. As other electrolyte, for example, a high molecular weight electrolyte, in which an electrolyte salt is dispersed in a high molecular weight compound having ion conductivity; an inorganic solid electrolyte composed of ion conductive ceramics, ion conductive glass, ionic crystal or the like; a molten salt electrolyte; or a mixture thereof can be cited.

Further, in the foregoing embodiment and examples, descriptions have been given with reference to the cylindrical-type secondary battery or the secondary battery using the package member such as a laminated film. However, the present invention can be similarly applied to a secondary battery having other shape such as a coin-type battery, a button-type battery, and a square-type battery having other structure, or a secondary battery having other structure such as a winding structure. Further, the present invention can be also applied to other battery such as a primary battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A cathode comprising a current collector having an active material layer, wherein the active material layer has a multilayer structure containing different active materials.

2. A cathode according to claim 1, wherein the active material layer has a first layer containing a first active material and a second layer containing a second active material having heat stability higher than of the first active material.

3. A cathode according to claim 2, wherein the second layer is provided on at least one of a current collector side of the first layer and an opposite side thereof.

4. A cathode according to claim 2, wherein the second active material has a smaller weight loss at 400 deg C. by thermogravimetry as compound to the first active material.

5. A cathode according to claim 2, wherein the first active material is a complex oxide containing lithium and nickel, and the second active material is a phosphorus compound containing lithium and iron.

6. A battery comprising:
a cathode;
an anode; and
an electrolyte,
wherein the cathode has a current collector and an active material layer provided on the current collector, and
the active material layer has a multilayer structure containing different active materials.

7. A battery according to claim 6, wherein the active material layer has a first layer containing a first active material and a second layer containing a second active material having heat stability higher as compared to the first active material.

8. A battery according to claim 7, wherein the second layer is provided on at least one of the current collector side of the first layer and an opposite side thereof.

9. A battery according to claim 7, wherein the second active material has a smaller weight loss at 400 deg C. by thermogravimetry as compared to the first active material.

10. A battery according to claim 7, wherein the first active material is a complex oxide containing lithium and nickel, and the second active material is a phosphorus compound containing lithium and iron.

11. A battery according to claim 6, wherein the cathode and the anode contain an active material capable of inserting and extracting lithium.
